(19) United States
(12) Patent Application Publication
(10) Pub. No.: US 2011/0212018 A1
(43) Pub. Date: Sep. 1, 2011

(54) Apparatus for confinement of the short-lived hydroxyradical OH associated with ozone reaction processes

(76) Inventor: Edward R. Otero, Palm Springs, CA (US)

(21) Appl. No.: 12/932,681

(22) Filed: Mar. 3, 2011

Related U.S. Application Data
(63) Continuation-in-part of application No. 12/657,170, filed on Jan. 15, 2010.
(60) Provisional application No. 61/273,147, filed on Jul. 31, 2009.

(51) Int. Cl. B01J 19/08; C01B 13/14

(52) U.S. Cl. 423/579; 422/186.15; 422/186.18

(57) ABSTRACT

The output of a flow restricting ozone generator assembly is connected through a conveying chamber to a low pressure port of a venturi nozzle which is inserted into the water circulating plumbing of a pool or spa. The conveying chamber then stores the water vapors from the water flow through the nozzle which are communicated to the ozone generator to promote the reaction products hydroxyradical OH that is then drawn through the port to mix with the circulating water flow. A spring biased valve at the inlet to the ozone generator is urged to close upon the instance when the flow through the nozzle ceases, terminating the low pressure at its throat and thereby fully confusing the reaction products from inadvertent escape.

### REFERENCE TO RELATED APPLICATIONS

This application is a continuation-in-part of U.S. Utility patent application Ser. No. 12/657,170 filed Jan. 15, 2010, which, in turn, obtains the benefit of the earlier filing date of US Provisional Application Serial No. Ser. No. 61/273,147 filed on Jul. 31, 2009, and the benefit of these earlier dates is claimed for all matter common therewith.

### BACKGROUND OF THE INVENTION

1. Field of the Invention

The present invention relates to ozone generating systems useful in pools and spas, and more particularly to an ozone generator gas flow routing and confinement structure to insure that the highly reactive, secondary short-lived hydroxyradical OH reaction processes produced as a component of the reaction of ozone [O3] with water is fully confined within a closed portion of a water circuit.

2. Description of the Prior Art

Throughout history the human race has been in a constant struggle for a safe place to live, perpetually searching for better and more effective mechanisms that help keep our immediate surroundings safe. In this perennial campaign for a safe place to raise his progeny man has expended and continues to expend great effort to oppose, or at least reduce the variety, vigor and volume of the various parasites and pathogens that persistently try to invade and infest virtually all our places of habitation. Today this effort entails various chemicals that themselves pose a risk to human health, as for example the currently predominating use of chlorine [Cl] employed for its oxidation reaction that results from its elevated reduction-oxidation (redox) potential.

Of course, when the threat perceived by us is more acute, like the direct threat to life from infection that may be passed through an open wound or other breach of the protective barrier of one's skin, our usual response is to reach for ever higher oxidation mechanisms like those obtained through the use of hydrogen peroxide [H2O2], thus recognizing the preference for ever higher oxidation potentials as things get more serious. As evolutionary adaptation continues nonetheless and the widely practiced use of chlorine in all of our general cleaning efforts has been challenged recently by various adapting responses within the pathogen and parasite ranks, the efficacy of this cleaning agent is no longer as profound as in its earlier days. As result our focus is turning to other, even higher redox potentials including those provided by oxygen itself when combined within a charged field into ozone [O3].

Clearly, this very confined and selective preference scale for these ever higher redox potentials indicates some concerns over the negative aspects that these agents, themselves, may pose. In the main this concern focuses on the reaction processes that form directly as oxides of nitrogen [NOX like NO2, etc.], resulting in nitrous and/or nitric acid lung, eye lining and other tissue irritant, and it is this acidic reaction chain that is at the current center of our regulatory attention.

The reaction of ozone with water, however, is one also effected by an indirect reaction process in which the ozone is first disintegrated into short-lived OH-radicals, or hydroxyradicals, that have even a greater oxidation potential (2.86v vs. 2.07v) than ozone [O3] itself. Most often this secondary free radical production is associated with an exposure of the ozone gas to ultraviolet [UV] radiation, as suggested by the various air quality regulatory agencies and also in U.S. Pat. Nos. 7,763,206 to Mole; 7,662,295 to Brolin et al.; 7,045,096 to D'Ottone; 6,358,478 to Soeremark; and many others.

This focus on a separate UV generating source, or on the naturally occurring UV radiation background, has effectively masked the use of the ozone generator itself, and particularly the coronal edge discharge patterns thereof, as its own source of free radical production and only a few prior art references suggest this electrode geometry effect. This effect is noted, for example, in the use of a sharp center electrode shape taught in U.S. Pat. No. 5,935,339 to Henderson et al. to inherently generate the free radical stream directly within the ozone plasma which is then utilized (by the electron scavenging cascade processes associated with free radicals) to clean debris accumulated on a surface.

The same cascading electron scavenging processes that are at the heart of the water purification mechanism associated with ozone are also at the center of some of the current concerns over the safety of this exact method. Notably, the production of this same exact free radical OH occurs mainly in the presence of water, or the vapors thereof, implicitly demanding that the coronal discharge field of an ozone generator include significantly large electrode gaps in order to limit any adverse effect on the driving circuit that produces this charge. This lower electrode gap limit, however, has been recently overcome by me, together with Peter K. C. Yeh, in an electrical feedback circuit arrangement described in our U.S. patent application Ser. No. 12/657,170 filed on Jan. 15, 2010, with its teachings included herein.

The accommodation of much smaller electrode gaps that has thus been rendered possible allows the use of the ozone generating structure itself both to generate ozone in its coronal fields and also to function as a flow restrictor. In this manner the generator output flow may be dropped to sufficiently low pressures to evoke a continuing supply of water vapor within a cavity exposed to the pool or spa circulating water flow and return to this flow the resulting free radical stream, thus confining these reactive products, and it is this operation and structure that are described herein.

### SUMMARY OF THE INVENTION

Accordingly, it is the general purpose and object of the present invention to provide an active confinement mechanism connected between the output opening of an ozone generator dimensioned and shaped to act as a flow restrictor and the low pressure inlet port of a venturi nozzle conveying a flow of water therethrough.

Other objects of the invention are to provide a pressure controlling ball valve assembly at the output of a flow restricting ozone generator to enable air flow therethrough when the pressure downstream of said valve is below a predetermined level.

Yet additional and further objects of the invention shall become apparent upon the review of the teachings that follow together with the drawings appended hereto.

Briefly, these and other objects are accomplished within the present invention by connecting a spring biased ball valve to the input opening of a cylindrical ozone cell or generator provided with coaxially conformed electrodes that are radially spaced from each other by a minimal radial gap both to assure a complete coronal field within which the atmospheric oxygen O2 that is conveyed with the air flow is converted to ozone [O3] and to form an effective flow restriction. The low pressure side of this ozone generator is then connected to a tubular chamber communicating with the low pressure inlet port of a venturi nozzle connected into the pool or spa circulating system to convey the water flow, now mixed with the generated ozone, through the various traps and filters where for the usual circulation rates through the venturi nozzle radial gaps as small as 0.05 to 0.25 millimeters in a nominally 9 millimeter diameter annular section were found useful.

In this serial component arrangement once the venturi pressure drops below the spring bias of the ball valve to lift the ball from its mating seat a low pressure is developed within the tubular chamber which extends to the downstream edge pattern of the coronal discharge field between the coaxial electrodes of the ozone generator at one end and the low pressure venture opening at the other end. In the course of this opening transient as this low pressure cavity is thus formed the resulting pressure drop across the narrow annular electrode gap equilibrates with the gas flow ingested into the venturi nozzle by a partial vapor pressure make-up from the water flow through the venturi nozzle and/or the vapor previously precipitated on the cavity surfaces, resulting in a generally saturated or high humidity state. These high humidity levels at or near the coronal fringe ensure a fully supplied reagent complement to form the more reactive hydroxyradicals OH in preference over the various NOX reaction products that are the current focus of our concern.

Of course, this same component arrangement, and particularly the flow restriction between the generator electrodes, also effectively damps out all cavity pressure fluctuations that may be associated with any second order effects, like the spring-ball combination of the ball valve, or any pressure harmonics, thus damping any second order effects such as any gas pressure resonances within the chamber, insuring a resulting flow that is well controlled and confined to enter directly into the venturi nozzle where it is mixed with the high mass rates of the water stream that is to be sanitized. In this manner the OH electron scavenging cascades are wholly confined to an area where they serve best, i.e., to react only with whatever matter being carried in the water flow, with the flow restricting nature of the generator itself assuring a complete consumption of these highly reactive radicals in the sanitizing process.

The reduced atmospheric levels and the much higher levels of water vapor in this arrangement will, of necessity, entail water condensate across the electrode gap of the generator and thus its driving circuit will require substantial tolerance to this variable in its operation. To achieve the wide tolerances needed accommodate these condensate swings, and thus to insure continuous operation both in a quiescent setting and also in virtually all vigorous use levels of pool or spa, the generator's closely spaced electrodes between which the air flow is conveyed are each respectively connected to one corresponding end of the high potential secondary winding of a transformer. In this form the circuit acts as a resonant tank circuit that varies in its response with the content of the matter within the electrode gap that result in electrode gap impedance to modify the coronal production.

At its primary side the transformer is provided with two separately connected primary windings, the first of which is connected to a Zener diode referenced power source controlled by a first operational amplifier circuit which collects at its negative input the output of a second operational amplifier tied at its input to the second primary winding. Since both the first and the second primary winding are inductively coupled to the secondary winding each will respond to the impedance changes within the electrode gap and the inverted connection of the second operational amplifier therefore provides a convenient feedback arrangement attenuating the effects of these changes.

The foregoing feedback arrangement takes benefit of the expanded operating range obtained by the use of operational amplifier circuits which therefore allows a much broader range of operation that can accommodate all sorts of activity levels in the spa or pool and therefore a wide variation range in the moisture content levels between the electrodes. In this manner the high moisture content necessary for the hydroxyradical production synergistically coincides with the high level of pool use that is also often associated with high levels of contamination.

### BRIEF DESCRIPTION OF THE DRAWINGS

FIG. 1 is a diagrammatic illustration of the functional blocks of a transformer driven ozone generating system providing feedback compensation to the circuit driving a first separately connected transformer primary winding in response to the electrode gap impedance changes sensed by a second separately connected primary winding;

FIG. 2 is a circuit diagram illustrating the preferred circuit connections of a feedback arrangement in accordance with the general illustration in FIG. 1;

FIG. 3 is a diagrammatic illustration of a typical pool filter water circulation system modified to include a closed low pressure loop inventively connected to the atmosphere by a pressure regulating ball valve communicating across a flow restricting ozone generating structure electrically excited by the feedback compensated circuit shown in FIGS. 1 and 2 and communicating the ozone reaction product stream therefrom through a low pressure port of a venturi nozzle with the circulating water flow;

FIG. 4 is a perspective illustration, separated by parts, of a commercially available ozone generator cell provided with flow restricting structural details;

FIG. 5 is a further sectional view of the spring loaded ball valve shown generally in FIG. 3 in conjunction with the invention herein; and

FIG. 6 is a diagrammatic illustration of the closed low pressure portion of the inventive ozone generating and mixing system juxtaposed against a pressure diagram illustrating the confining low pressure profile therein.

### DESCRIPTION OF THE PREFERRED EMBODIMENT

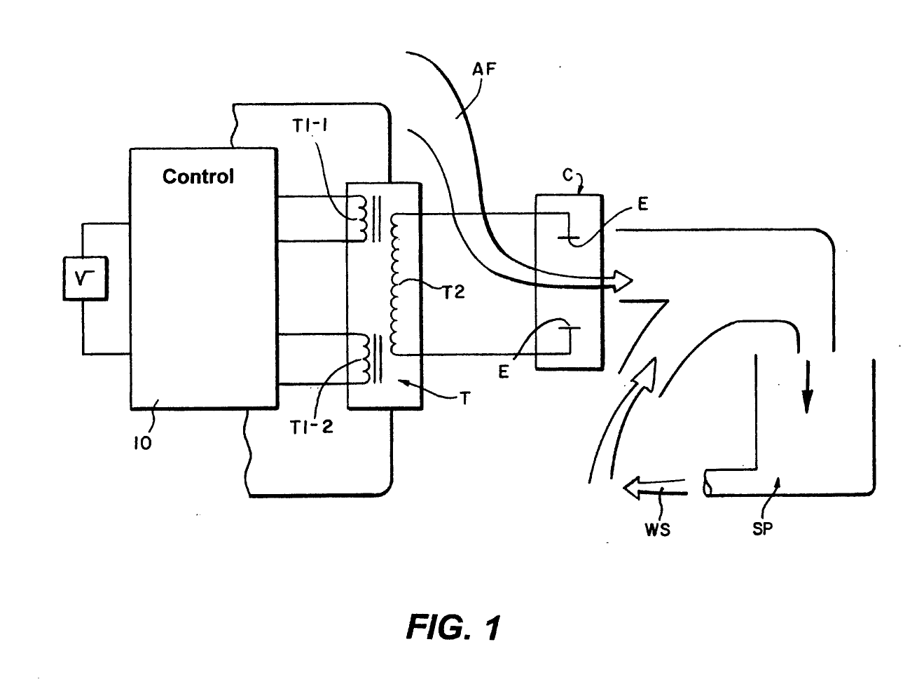

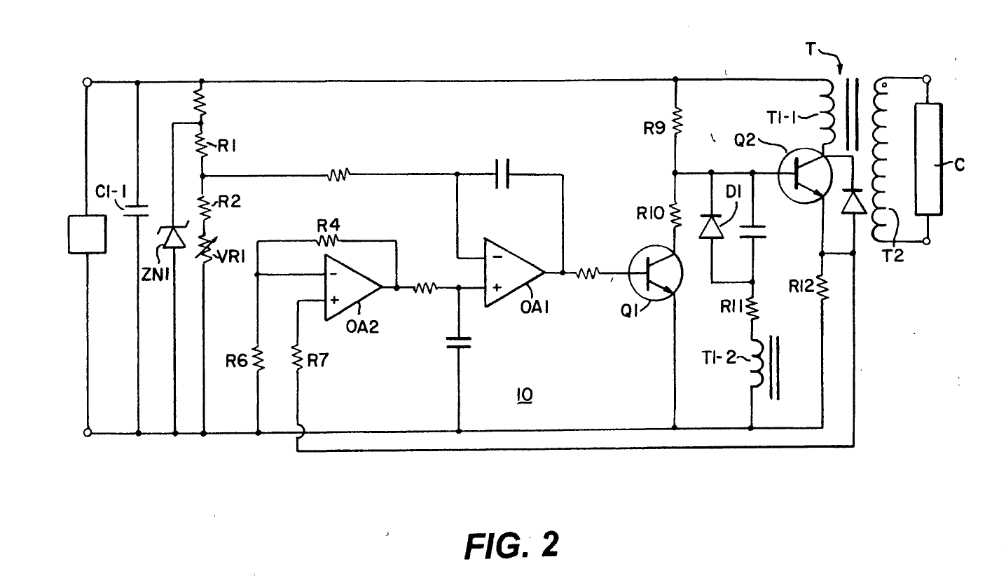

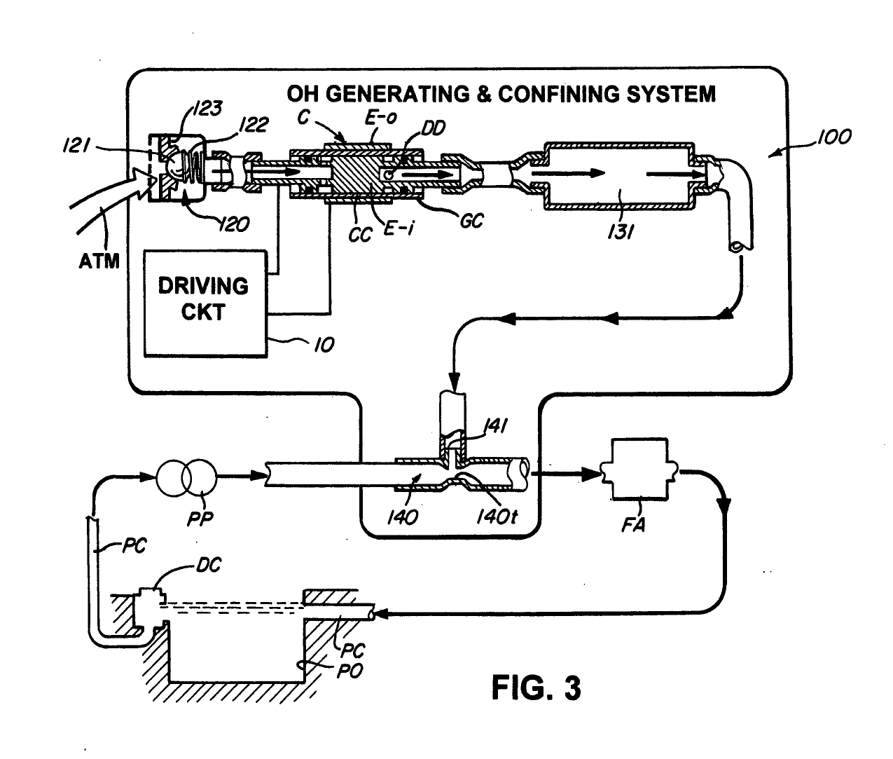

As shown in FIGS. 1 through 6 the inventive hydroxyradical generating and confining system, generally designated by the numeral 100, includes a flow restricting ozone generator cell C of the type sold by AquaSunOzone International, Inc., 605 Williams Rd., Palm Springs, Calif. 92264 under the designation ‘microcell’ which is provided with concentric, closely spaced electrodes E connected for excitation to a feedback compensated driving circuit, generally designated by the numeral 10. The foregoing connection is effected at the ends of a high voltage secondary winding T2 of a step-up transformer T bridging the gap across the electrodes E through which a current of air AF drawn across a spring loaded ball valve 120 is conveyed.

Those skilled in the art will appreciate that the voltage across the secondary winding T2 is stepped up to a level sufficiently high to develop a coronal plasma discharge to produce ozone and, of course, such excitation level is best achieved at, or close to, the effective or equivalent circuit resonance that includes any varying effects of the dielectric separating the electrodes E together with any of its various inductive and resistive components. In this configuration these impedance components will exhibit large changes in consequence to any back-flooding and/or whole or partial immersion of the electrode gap, greatly modifying the resonating nature of the circuit and therefore also its consequent levels of production of ozone.

compensate for these impedance variations in a control arrangement that retains sufficient substantially linear control authority the transformer T is provided with two separately connected primary windings T1-1 and T1-2 with the winding T1-1 connected in the control circuit 10 between the collector of a transistor Q2 and the high voltage side of a source or input of electrical excitation V. Thus when the transformer secondary T2 reflects a drop in impedance into the primary winding T1-1 the collector voltage of transistor Q2 rises to the potential of the source V, as smoothed and filtered by a capacitor C1-1, and if transistor Q2 is driven to conduct by its base signal its emitter signal is also commensurately pulled up in accordance with the resistance of an emitter resistor R12 connected to the other side of the input source V.

The conduction of transistor Q2 is determined by a series connection including a diode D1, resistor R11 and the other primary winding T1-2 bridging the division point between two resistors R9 and R10 collected between the high side of the source V and the collector of yet another transistor Q1 controlled into conduction by the output of an operational amplifier OA1 connected as a comparator that compares the output of yet another operational amplifier OA2. Amplifier OA2, in turn, collects in subtraction the emitter signal (at resistor R12) of transistor Q2 with a division point across a Zener diode ZN1 formed by resistors R1, R2 and a variable resistor VR1, thus providing a linear expression (within the amplifier's saturation limits) of the impedance sensed by the feedback winding T1-1. At the same time the impedance drop of the second primary winding T1-2, as coupled across diode D1 and capacitor C4 to the base of transistor Q2, limits the conduction interval thereof to limit the power available for ozone generation with similar frequency responses obtained by capacitors C2 and C3 in the input and feedback of operational amplifier OA1.

In the foregoing form the benefits of operational amplifier OA2 connected for a linear operation by a feedback resistor R4 are obtained to expand the effective operating range within which ozone production will continue, thus retaining its functional efficacy in all the transitory states when substantial mist and vapor is generated. In this manner the continued functioning of the ozone cell C is thus greatly enlarged to include periodic instances of condensation that may occur as result of pressure fluctuations associated with high activity and use of the pool or spa that is to be sterilized, an attribute that is also particularly useful to promote ozone reactions with water to produce the highly reactive hydroxyradicals OH.

To further promote the preferential formation of hydroxyradicals OH the dimensional and geometric selections of the particular ozone cell C are such that a substantial flow restriction results. More precisely, this ozone cell configuration includes a generally cylindrical inner electrode E-i having a central segment thereof coaxially extending through a radially spaced glass cylinder GC that encloses a generally circular cavity CC which communicates through drillings DD into each of the exposed ends of electrode E-i so that a tortuous and dimensionally constrained flow path is established therethrough. An outer electrode E-o shaped as a tubular segment on the exterior of the glass cylinder GC then completes the circuit across the driving circuit 10, with the edges of the outer electrode providing the discontinuity where coronal fringe patterns develop.

One end of the inner electrode E-i is then connected to the outlet of the spring loaded ball valve 120 in which a non-corrosive ball 121 is urged by a spring 122 against a resilient annular seat 123 communicating to the local atmosphere ATM across a screened opening 124. The other end of cell C, in turn, connects through a tubular chamber 131 to the low pressure opening 141 of a venture nozzle 140 connected in the pool circulation circuit PC to convey the water flow from the pool pump PP to filter assembly FA. Of course, this same pool circulation circuit may also include the various debris collection chambers DC deployed in the conveyance path between the pool PO and the pump PP which are separated from the ozone output by the water volume in the pool.

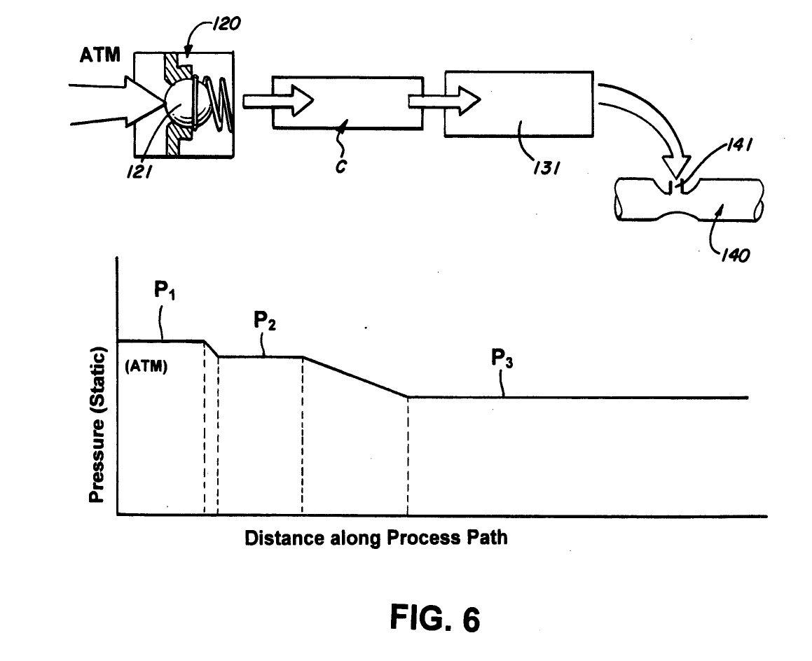

By particular reference to FIG. 6, the foregoing arrangement confines at sub-atmospheric pressures all the highly reactive hydroxyradical reaction products until they enter the high mass flow of the pool circuit PC. This low pressure confinement includes the volume of chamber 131 which is essentially at the venturi suction pressure determined by the locally increased flow rate at the throat 140t of the nozzle 140 and therefore invariably will include at least some water condensate right adjacent the downstream coronal edge fringe formed by the outer electrode E-o, with the upstream edge clearly closer to the inlet pressure set by the ball valve 120. Thus an associated pressure profile is defined between the atmospheric pressure P1 at port 124 which then drops somewhat to P2 upon the lifting of ball 121 from its lipped resilient seat 125 to drop along the length of cell C to the low pressure lever P3 of the venturi port 141 that extends through chamber 131 including the downstream edge fringe of electrode E-o. When the suction stops the ball returns to the seat 125, sealing off the radicals produced.

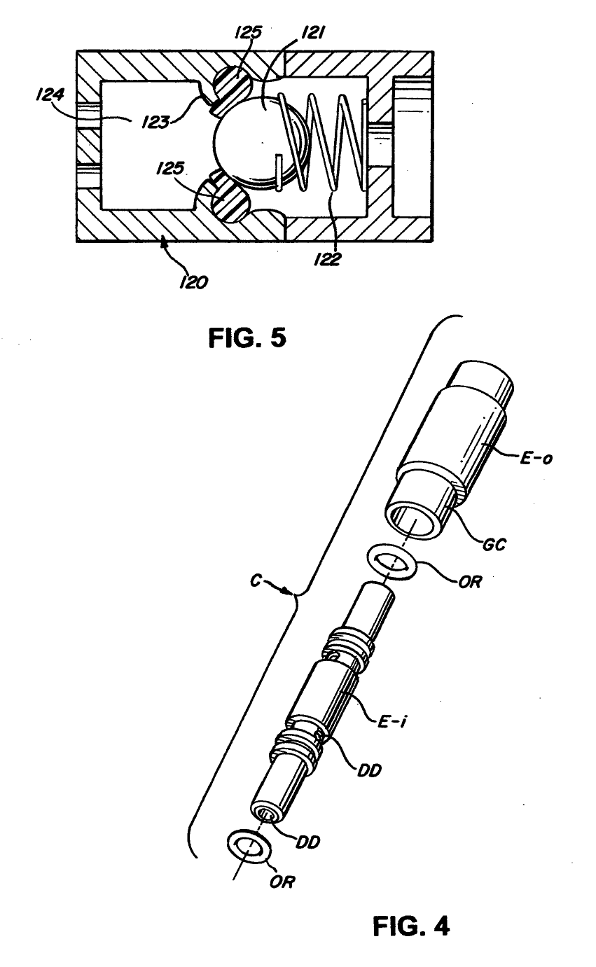

Those skilled in the art will appreciate that the flow rates through the circulation circuit PC are determined both by the density of the pool use and also by the restricting accumulation of any debris in the collection chamber (or chambers) DC. Of course, these varying flow rates and sanitation requirements need to be accommodated either by the length of time that the pump PP remains powered and/or by the air flow through cell C. As particularly illustrated in FIG. 4, this variable in use is conveniently achieved by the flexibility in the flow gap CC selection that is obtainable by a mounting arrangement effected by O-rings OR that allow receipt of various interior electrode E-i dimensions within the interior of the glass cylinder GC.

Thus the inventive arrangement conveniently confines at low pressures the highly reactive free radicals in a structure that also promotes the presence of water vapor at the downstream coronal fringe across which at the upstream generated ozone is passing. More importantly, as a direct consequence to the higher reactivity associated with the hydroxyradical OH a substantially lower production level of ozone [O3] is required, again a self-reinforcing attribute as it allows the much narrower spacings, passages and gaps in the generator cell. As result even lower venturi pressure levels can be utilized, further improving its confinement and also the resulting higher vapor levels that further improve preduction efficiency, and so on.

Obviously many modifications and variations of the instant invention can be effected without departing from the spirit of the teachings herein. It is therefore intended that the scope of the invention be determined solely by the claims appended hereto.

I claim:

1. Apparatus for promoting the production of hydroxyradical OH in the course of a reaction of ozone with water, and to confine said hydroxyradical OH reaction products for mixing with the water circulating stream of a pool, comprising:
a venturi nozzle connected to convey said circulating stream and including a low pressure port;
a confining cavity defined by an upstream and a downstream end having said downstream end connected to said low pressure port;
an air flow restricting ozone generating assembly including an inlet end and an outlet end at the edges of spaced electrodes therebetween connected at said outlet end to said upstream end of said confining cavity; and
a pressure actuated valve assembly communicating with the adjacent atmosphere and connected to said inlet end of said ozone generating assembly; and
a feedback compensating electrical excitation circuit connected across said spaced electrodes.

2. Apparatus according to claim 1, wherein:
said spaced electrodes include a cylindrical inner electrode coaxially received in a radially spaced alignment within a tubular insulator having an external electrode mounted on the exterior thereof.

3. Apparatus according to claim 2, wherein:
said inner electrode is radially spaced from said tubular insulator by a radial gap of 0.05 to 0.25 millimeters at a radius of generally 4.5 millimeters.

4. Apparatus according to claim 1, wherein:
said pressure actuated valve assembly includes a spring biased ball valve.

5. Apparatus according to claim 4, wherein:
said spaced electrodes include a cylindrical inner electrode coaxially received in a radially spaced alignment within a tubular insulator having an external electrode mounted on the exterior thereof.

6. Apparatus according to claim 5, wherein:
said inner electrode is radially spaced from said tubular insulator by a radial gap of 0.05 to 0.25 millimeters at a radius of generally 4.5 millimeters.

7. A method for promoting and thereafter confining the reaction products hydroxyradical OH produced in the course of a reaction of ozone with water within the circulating water stream of a pool, comprising the steps of:
generating a low pressure source by accelerating said circulating water stream through a reduced section of a venturi nozzle;
communicating said low pressure to the outlet of an ozone generator cell dimensioned to form a flow restriction between the electrodes thereof; and
connecting the inlet of said generator cell to the atmosphere across a pressure actuated valve assembly.

8. The method according to claim 7, wherein:
said step of communicating said low pressure includes the further step of providing a confining chamber connected between said flow restriction and said outlet of said ozone generator.

9. The method according to claim 8, wherein:
said step of connecting said inlet of said generator to the atmosphere further includes a spring biased ball valve.

10. In a water circulating circuit useful in circulating a water stream through the filter of a pool, the improvement comprising:
a venturi nozzle inserted in series in said water circulating circuit, said nozzle including a reduced flow area portion and a port communicating with said reduced flow area portion;
a confining chamber defined by a first and a second end having said second end connected to said port;
an ozone generator cell including a first generally cylindrical electrode and a coaxial generally tubular second electrode surrounding said first electrode to form a restrictive annular space therebetween having an inlet and an outlet connected to said second end; and
a pressure actuated valve assembly connected between said inlet and the adjacent atmosphere.

11. The improvement according to claim 10, wherein:
said pressure actuated valve assembly includes a spring biased ball valve.

12. The improvement according to claim 11, wherein:
said second electrode includes a tubular insulator on the interior thereof.
